(19) United States
(12) Patent Application Publication
(10) Pub. No.: US 2008/0121683 A1
(43) Pub. Date: May 29, 2008

(54) Score counter

(76) Inventor: Allen Gary Duncan, Radford, VA (US)

Correspondence Address: ALLEN GARY DUNCAN, 7526 LITTLE RIVER DAM RD., RADFORD, VA, 24141, US

(21) Appl. No.: 11/604,111

(22) Filed: Nov. 24, 2006

(51) Int. Cl. A63B 71/06; G06M 1/22

(52) U.S. Cl. 235/127

(57) ABSTRACT

This invention is a mechanical device that counts golf strokes per hole. It is designed to be worn on a golfer's wrist, on a lanyard, placed in a pocket, or clipped on one's clothing. The device allows a full range of non-restrictive movement. The counter is indexed between twelve positions, patterned after the hours of an analog clock, thus the score is easily read. The starting position is at 12 o'clock, first shot is 1 o'clock, second shot is 2 o'clock, etc. This design enables the user to simply click to the subsequent position without the need to read the display. The pointer is mounted to a base and rotates, having 12 equally spaced positions. Each position is secured in place by means of a ball or radius shaft that is spring-loaded into one of the 12 equally spaced indentations in the base. The ball requires little or no friction during indexing but provides sufficient holding pressure, ensuring that the indicator is held firmly into position.

### FIELD OF THE INVENTION

The present invention relates to score keeper for events and, more particularly, to keeping the strokes per hole during a golf game.

2. Background Art

Golfing requires much concentration and the need to accurately remember the number of strokes taken to put the ball in each hole. Remembering the number of strokes per hole can create stress and negatively affect one's game.

Recording devices currently available require good vision and skill to operate. Thus if a golfer requires wearing reading glasses, extra care is taken to keep up with the glasses. In addition extra thought must be given to ensure the correct process is taken (or the right button is pushed) to keep the score accurate.

Inaccurate score keeping in a round of golf is considered unprofessional and can lead to hostile situations during the game.

In the U.S. Pat. No. 4,922,850 issue to Conley, the U.S. Pat. No. 3,847,110 issued to Inoue, and the U.S. Pat. No. 4,557,215 issued to Petersson, golf score counters are described. However all of these frictionally engage the score position and do not snap into the score position.

In the U.S. Pat. No. 6,401,252 issued to Boller and U.S. Pat. No. 4,367,526 issued to McGeary, golf score counters are described. However, they require a battery or solar cell to operate.

In the U.S. Pat. No. 1,460,842 issued to Brooks, a golf stroke counter is described. However the lock-into position piece scrapes over the base during indexing, creating undesirable friction.

### OBJECTS AND ADVANTAGES

Accordingly, it is a primary object of the present invention to provide an accurate method for a golfer to keep track of the number of shots taken to put the ball in the hole, patterned after the hour positions of an analog clock.

It is a further object of the invention to provide a score keeper that can be used to easily determine the score or enter a stroke with minimum or no vision required.

It is a further object of the invention to provide a score keeper that can be worn on the arm as a watch, on a lanyard, kept in a pocket, or clipped on a golfer's belt.

It is a further object of the invention to provide a score keeper that requires no electrical source of energy.

### SUMMARY

These objects and advantages are attained by providing a score keeper patterned after the positions on an analog clock. The indexing positions correspond to the positions of a 12 hour analog clock face, providing the user quickly recognizable access to the score attained. The user operates the device by turning the rotating dial to the next clockwise position, where it clicks into place. At the conclusion of each hole, the user records the score and easily resets the dial by moving it back to starting “0” (12 o'clock) position.

### BRIEF DESCRIPTION OF THE DRAWINGS

A complete understanding of the present invention may be obtained by reference to the accompanying drawings, when considered in conjunction with the subsequent, detailed description, in which:

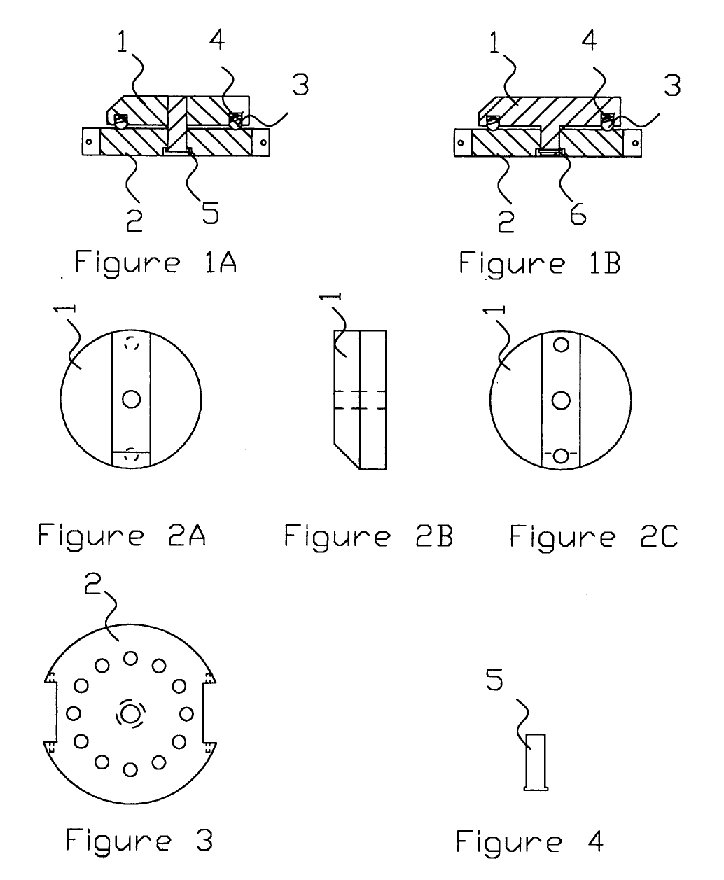

1. FIG. 1A is a cross-sectional assembly view of a Score Keeper preferred design.

2. FIG. 1B is a cross-sectional view assembly of a Score Keeper optional design.

3. FIG. 2A is the top view of the Score Keeper indicator member.

4. FIG. 2B is the front view of the Score Keeper indicator member.

5. FIG. 2C is the bottom view of the Score Keeper indicator member.

6. FIG. 3 is the top view of the base member.

7. FIG. 4 is a side view of the shaft member.

For purposes of clarity and brevity, like elements and components will bear the same designations and numbering throughout the FIGURES.

### DESCRIPTION OF THE PREFERRED EMBODIMENT

Although the following detailed description contains many specifics for the purpose of illustration, anyone with ordinary skill in the art will appreciate that many variations and alterations to the following details are within the scope of the invention. Accordingly, the following preferred embodiment of the invention is set forth without any loss of generality to, and without imposing limitations upon, the claimed invention.

A preferred embodiment of the invention is shown in FIG. 1A. An indicator 1 can rotate around base 2, stopping at one of twelve positions. FIG. 3 shows the base 2 with twelve indentations. These indentations allow the ball 3 or balls to enter and act as a position holder. A coil spring 4 or springs provide tension to the ball 3, thus creating holding position. Shaft 5, shown in FIG. 1A, is bonded or pressed into indicator 1. Alternatively, a retaining ring 6, shown in FIG. 1B, may be used to keep the indicator 1 and base 2 together.

In the preferred embodiment, the user would start the score keeper at the twelve o'clock position. After each stroke during an event, the indicator 1 would be rotated one clockwise index.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A score counter comprising:
a) Abase
b) An indicator that can be rotated in said base
Whereby said indicator will lock into position while being indexed.

2. A score counter comprising:
a) Said indicator rotating on said base, stopping at one of twelve positions.
This indicates the score similar to reading by an analog clock;
b) Means for ball or radius shaft used to secure indicator into position;
c) Means for spring used to add force to ball or radius shaft; and
d) Means to hold the indicator and the base together.
